(19) United States
(12) Patent Application Publication
(10) Pub. No.: US 2011/0196070 A1
(43) Pub. Date: Aug. 11, 2011

(54) HYDROPHOBING AGENT

(76) Inventors: Adrian Keller, Rupperswil (CH); Paul Emmenegger, Oberkirch (CH); Dominique Schaub, Hinwil (CH)

(21) Appl. No.: 13/056,465

(22) PCT Filed: Jul. 24, 2009
(86) PCT No.: PCT/EP09/59536

§ 371 Date: Jan. 28, 2011

Related U.S. Application Data
(60) Provisional application No. 61/091,057, filed on Aug. 22, 2008.

(30) Foreign Application Priority Data
Jul. 28, 2008 (EP) 08161280.6

(51) Int. Cl. C04B 28/00; C08K 5/541; B01J 31/12; B01J 37/04

(52) U.S. Cl. 524/4; 524/261; 502/152; 502/1

(57) ABSTRACT

The present invention concerns a process to hydrophobize mortars, characterized in that a dry mortar is mixed with water, applied onto a substrate and allowed to dry, the dry mortar being preferably a gypsum dry mortar and/or containing no or less than about 5 wt. % of a minerally setting binder, calculated on the dry content of the dry mortar, wherein at least one solid hydrophobizing material is added before, during and/or after mixing of the dry mortar with water and/or the hydrophobizing material is mixed with water and applied onto the dried mortar, wherein the hydrophobizing material is a hydrophobizing agent containing a silane, a carrier, and a catalyst, and/or a silane composition containing at least a silane and a carrier and a catalyst composition containing at least a catalyst and a carrier, wherein the silane and catalyst compositions are added to the mortar together and/or separately before, during and/or after mixing of the mortar with water, wherein the silane has at least one Si—OR group and R is an organic group, wherein the catalyst is suitable for hydrolyzing the Si—OR bond and/or for condensation of the Si—OH group obtained by hydrolysis, and wherein the hydrophobizing agent, the silane composition and/or the catalyst composition are preferably in the form of a powder, granulate and/or flakes. Claimed in addition are the products obtainable by the above process and water-dispersible, water-redispersible or water-soluble catalyst compositions and hydrophobizing agents suitable for use in the process.

The invention pertains to a process to hydrophobize mortars, a hydrophobizing agent and a catalyst composition suitable for hydrophobizing masses, in particular gypsum-based and cement- and gypsum-free masses, the manufacturing process and use thereof, as well as to mortars containing the hydrophobizing agent and/or the catalyst composition.

Gypsum, in particular in the form of hydraulically setting calcium sulfate such as α- and β-hemihydrate or in the form of anhydrite I, II or III, is a very common building raw material and is applied in a plurality of the most widely different formulations and embodiments, such as for instance in drywall installation, where gypsum plasterboard is often used, in plastering for indoor use, in tile adhesives, in the flooring area, as well as in the handyman or do-it-yourself segment.

A major drawback to hydraulically setting gypsum materials, however, is their sensitivity to water, as it precludes exterior application or application in rooms with increased atmospheric moisture such as wet cells. For that reason it has been tried time and again to formulate gypsum products in such a way that the cured gypsum products have a hydrophobizing nature and/or a reduced water absorption, in order to increase the water resistance.

Thus various technologies are described which use liquid silicon-based compounds, such as for instance silanes, siloxanes, alkoxysilanes and/or organosilanes, as hydrophobizing components in order to obtain an increased water resistance, wherein use can be made of a catalyst and/or the work can be done at acidic or alkaline pH-value.

For instance, EP 1 698 602 A1 describes a gypsum mixture with improved mechanical and hydrophobic properties, containing a uniformly dispersed additive consisting of at least one alkoxysilane and/or alkoxy-functionalized polysilane and at least one salt of mineral acids and metals of Subgroups IIIB to VIII, IB or IIB, with the metal salts not standing for metal salts which catalyze the silanol condensation to any noticeable extent. For the preparation of the gypsum mixture the silane component and the metal salt are first mixed with the water in any order. Next, a gypsum paste is prepared by introducing a commercially available builder's gypsum into the aqueous mixtures.

In WO 02/00799 A1 a composition is described which contains a mixture of water or a solvent, a methyl hydrogensiloxane polymer or copolymer, an alkoxysilane of the formula RₐSi(OR′)₄₋ₐ, and a silicone resin. This mixture can int. al. also contain a catalyst such as dibutyltin dilaurate and is used for surface refining of mineral substrates such as burnt brick, roofing tiles, and gypsum boards.

WO 81/01702 describes a process for the preparation of plasters containing gypsum, water, conventional additives, and ballast material, where during the preparation int. al. alkoxysilanes and, optionally, a catalyst are added.

WO 2007/009935 A2 pertains to a 2-step method of preparing a mineral and/or filler material comprising (i) preparing a hydrolyzate containing polysiloxanes by hydrolyzing a hydrolyzable silane in the presence of an acid hydrolysis catalyst, and (ii) combining the polysiloxane hydrolyzate with at least one mineral and/or filler and optionally water and/or a catalyst for condensation of the hydrolyzate. This method is disclosed to be used to hydrophobize gypsum. A hydrophobizing agent in the form of a powder, granulate and/or flakes which can also be formulated into a dry gypsum mass is not described.

An important drawback to such systems is that they are made available only as 2-component systems, with the powdery gypsum components having to be mixed with further liquids in addition to water, such as liquid silicon-based compounds, on the building site immediately prior to application. This is an additional expense and can lead to quality problems. Therefore it is a major advantage when all necessary raw materials, in particular also the hydrophobizing components, are present in powder form. This makes it possible to prepare a dry mortar at the factory, which only has to be mixed with water on site before being processed.

Thus EP 278 518 A1 describes a process for the preparation of hydrophobic masses from gypsum, wherein use is made of organopolysiloxanes with Si-linked hydrogen in the form of powders.

EP 811 574 A1 discloses a cementitious material in powder form comprising cement and a granulated hydrophobing additive which comprises 5 to 15 parts by weight of an organopolysiloxane, 10 to 40 parts by weight of a water-soluble or water-dispersible binder, and from 50 to 80 parts by weight of a carrier particle, to give from 0.01 to 5% by weight of the organosiloxane component based on the weight of the cement. Silanes and catalysts are not disclosed.

WO 02/30846 A1 describes a granulated hydrophobing additive comprising from 50 to 90 parts by weight one or more palmitic, stearic or oleic acid salts of ammonia, aluminium, alkali metals, alkaline-earth metals or transition metals and/or an organic ester of palmitic, stearic or oleic acid or mixtures of said salts and esters, from 20 to 50 parts by weight of a water-soluble or water-dispersible binder, and from 0 to 20 parts by weight of an organopolysiloxane. Furthermore, a cementitious material in powder form is disclosed comprising cement and the granulated hydrophobing additive, preferably in amounts of 0.01 to 5 wt. % of the salt and/or ester component, based on the cement. Silanes, organometallic catalysts, and cement-free masses which can be rendered hydrophobic are not disclosed.

WO 02/30847 A1 describes a granulated hydrophobing additive comprising an organopolysiloxane wherein at least 10% of the substituents are hydrogen, a water-soluble or water-dispersible binder, and a carrier. Furthermore, a gypsum composition is disclosed comprising gypsum, a granulated hydrophobing additive comprising a silicon bonded hydrogen, a water-soluble or -dispersible binder, and a carrier, and a pH-effecting additive, preferably lime or a buffer solution, to maintain the pH of the composition between 8 and 12.5 in the presence of water. Silanes are not disclosed.

It has proved a major drawback when the pH-value of the mixed formulation is set as alkaline, since as a result for instance organic polymeric binders saponify and so lose their adhesive strength. In addition, paper, cardboard, and wood can change colour in a major way because of a too high pH-value of the alkaline formulation. When, on the contrary, a neutral pH-value is employed, it turns out that the water resistance and hydrophobicity with existing materials is insufficient.

Silanes have a number of advantages over organopolysiloxanes. Due to their low molecular weight, they are mobile. Furthermore, due to their chemical structure, they contain more hydrolyzable alkoxy groups per silicon atom than organopolysiloxanes. Hence, they are capable of leading to a higher crosslinking density and to a more pronounced three-dimensional network, which is an advantage when they are added to a matrix such as a mortar.

However, in general they are more difficult to handle than organopolysiloxanes. They have a lower viscosity and are more volatile, in particular at higher temperatures. Thus, when it is part of a solid, care must be taken that the silane does not evaporate e.g. during the preparation of the solid, in particular when the solid is obtained by drying an aqueous mixture, or during the storage of the solid at elevated temperatures such as e.g. 40° C. or even 60° C., even if this temperature is achieved for short times only. Therefore, their use in non-liquid hydrophobizing agents is not easily contemplated.

The objective of the present invention is to provide at least a process and materials for hydrophobizing mortars which at the same time also reduce the water absorption of the mortar. The materials should be easy to prepare and avoid the drawbacks of the state of the art, in particular lead to a good wetting of the mortar and if possible to a neutral pH-value of the formulation mixed with water. In addition, this additive should be usable for gypsum- and cement-free building materials. Another objective is that not only the surface of the mortar but also the mass as such should be hydrophobized, so that even in the case of scraped-off surfaces improved hydrophobicity is found.

Surprisingly, it was found that the objective can be attained by means of a process to hydrophobize mortars, characterized in that a dry mortar is mixed with water, applied onto a substrate, and allowed to dry, the dry mortar being preferably a gypsum dry mortar and/or containing no or less than about 5 wt. % of a minerally setting binder, calculated on the dry content of the dry mortar, wherein at least one solid hydrophobizing material is added before, during and/or after mixing of the dry mortar with water, and/or the hydrophobizing material is mixed with water and applied onto the dried mortar, wherein the hydrophobizing material is
i) a hydrophobizing agent containing a silane, a carrier, and a catalyst, and/or
ii) a silane composition containing at least a silane and a carrier and a catalyst composition containing at least a catalyst and a carrier, wherein the silane and catalyst compositions are added to the mortar together and/or separately before, during and/or after mixing of the mortar with water,
   wherein the silane has at least one Si—OR group and R is an organic group, the catalyst is suitable for hydrolyzing the Si—OR bond and/or for condensation of the Si—OH group obtained by hydrolysis, and wherein the hydrophobizing agent, the silane composition and/or the catalyst composition are preferably in the form of a powder, granulate and/or flakes.

Claimed also are hydrophobized dried mortars obtainable by the above process.

The invention also provides a dry mortar containing at least one solid hydrophobizing material, the hydrophobizing material being
i) a hydrophobizing agent containing a silane, a carrier, and a catalyst, and/or
ii) a silane composition containing at least a silane and a carrier and a catalyst composition containing at least a catalyst and a carrier,
   wherein the silane has at least one Si—OR group, wherein R is an organic group, the catalyst is suitable for hydrolyzing the Si—OR bond and/or for condensation of the Si—OH group obtained by hydrolysis, and wherein the hydrophobizing agent, the silane composition and/or the catalyst composition are preferably in the form of a powder, granulate and/or flakes.

Claimed is also a hydrophobizing agent containing at least one silane, one catalyst, and one carrier, wherein
i) the silane has at least one Si—OR group, wherein R is an organic group,
ii) the carrier is an inorganic carrier, an organic water-soluble and/or water-dispersible polymer,
iii) the catalyst is a catalyst for hydrolysis of the Si—OR bond and/or for condensation of the Si—OH group obtained by hydrolysis, and
wherein the hydrophobizing agent is present in solid form, preferably in the form of a powder, granulate and/or flakes.

The invention further provides a water-dispersible, water-redispersible or water-soluble catalyst composition containing at least
i) one carrier, wherein the carrier is at least one organic water-soluble and/or water-dispersible polymer, and
ii) one catalyst for hydrolysis of Si—OR bonds and/or for condensation of the Si—OH groups obtained by hydrolysis, wherein the catalyst is an organometallic compound,
wherein the catalyst composition is present in solid form, preferably as a powder, granulate and/or flakes.

The invention also provides a process for the preparation of the catalyst composition wherein
i) the catalyst is mixed with the carrier without the addition of water, wherein the carrier is a solid, in particular a powder and/or granulate, or
ii) the catalyst is mixed with the carrier in the presence of water and subsequently dried, wherein the carrier is a water-soluble and/or water-dispersible polymer.

Furthermore, a process for the preparation of the hydrophobizing agent is claimed, wherein
i) the silane with at least one Si—OR group is mixed with the carrier without the addition of water to a powder and/or granulate, and after that the catalyst is sprayed on and/or added as a separate powder and/or granulate, or
ii) the silane with at least one Si—OR group is mixed with the carrier in the presence of water and dried, wherein the carrier is a water-soluble or water-dispersible polymer, and the catalyst is added before, during and/or after the drying, or
iii) the at least one silane with at least one Si—OR group is mixed with the carrier and the catalyst in the presence of water and dried, wherein the catalyst is mixed with the carrier in a separate step, wherein the carrier is a water-soluble and/or water-dispersible polymer and the carrier mixed with the silane and the catalyst may be the same or different.

Additionally, the invention also provides the use of the inventive hydrophobizing agent and the inventive catalyst composition in and/or on masses for hydrophobizing the same, for reduction of the water absorption of masses, and/or for protection of masses and/or of metal coated with these masses against corrosion, wherein when the catalyst composition is used, it is brought into contact with at least one silane with at least one Si—OR group before, during and/or after the application.

The hydrophobizing agents according to the invention are suitable for use in a process for hydrophobizing masses, in which process they can be worked into the mass and/or be used for surface treatment of the mass. When they are worked into the mass, the whole mass is hydrophobized, even when the surface is damaged. In this case the term used is internal impregnation or mass hydrophobization. The hydrophobizing agents lead to a strongly reduced water absorption of the masses, even when these have a neutral pH-value. When use is made of the catalyst compositions according to the invention, these have to be brought into contact with at least one silane with at least one Si—OR group before, during and/or after the application in order to get the achieved effect.

In addition, the hydrophobizing agents according to the invention are suitable for protecting masses and/or metals against corrosion, in which case the metal is coated with masses containing the hydrophobizing agent according to the invention.

When in the process to hydrophobize mortars use is made of the catalyst composition according to the invention, the catalyst composition can be brought into contact with at least one silane with at least one Si—OR group before, during and/or after the application of the mortar mixed with water. When the catalyst composition and the silane are not added at the same time, the addition of the catalyst composition can take place before and/or after the silane with at least one Si—OR group is added. If the latter is present in the liquid form, it is often advantageous when the catalyst composition is mixed with the dry mortar at the factory.

Surprisingly, it was found that the masses containing the hydrophobizing agent and/or the catalyst compositions according to the invention and one or more silanes with at least one Si—OR group are also hydrophobized at about neutral pH-values of said masses. Thus, the pH-value of the masses, in particular mortars mixed with water, containing the hydrophobizing material, the hydrophobizing agent and/or the catalyst composition is typically between about 4 and about 10, preferably between about 5.5 and about 8.5, and in particular between about 5.5 and about 7.8. For purposes of this embodiment, the pH-value is determined by mixing and stirring equal amounts by weight of water and masses containing the hydrophobizing material, the hydrophobizing agent and/or the catalyst composition.

Since the hydrophobizing agent according to the invention and the catalyst composition according to the invention are present in solid form and preferably as a powder, granulate and/or flakes, it is possible to work them into a dry mixture already at the factory, which enables exact dosing and a homogeneous distribution and makes the preparation thereof particularly simple and economical. For use, this dry mixture then only has to be mixed with the corresponding amount of water and applied, which brings with it many advantages, such as for instance simple handling, simplified logistics and/or resistance to frost-thaw.

Surprisingly, it was found that the dry mortar formulations mixed with water, after being applied and dried and/or cured, have a hydrophobic surface and/or a reduced water absorption. The achieved reduction of the water absorption is greatly dependent on the formulation and on the amount of hydrophobizing material added. However, when a normal and sufficient amount is added, the obtained reduction of the water absorption is most typically about 35 wt. % or more preferably about 50 wt. % or more, in particular about 75 wt. % or more, compared with the same formulation without the hydrophobizing material, hydrophobizing agent or catalyst composition according to the invention.

With the hydrophobizing material, hydrophobizing agent, and catalyst composition according to the invention it has proved possible to prepare one-component products which, after they have been dispersed, redispersed and/or dissolved in water, are reactive even in the neutral pH-range and thus enter into the reactions necessary to achieve the desired effects.

It was a big surprise to find the hydrophobizing material as well as the hydrophobizing agent to be so stable and storable without deterioration, even though both contain a silane with at least one Si—OR group which reacts readily upon getting into contact with the catalyst—the latter being also part of the hydrophobizing material and the hydrophobizing agent. The person skilled in the art would rather expect the volatile silane, which is liquid at room temperature, to react with the catalyst when it is part of the same material. Thus, it was surprising to see that this does not occur as long as both the hydrophobizing material and the hydrophobizing agent are in solid form, such as being a powder, granules and/or flakes. And this good stability and storability happens despite the presence of the small amounts of water which are typically present in the hydrophobizing material and the hydrophobizing agent.

The hydrophobizing material, hydrophobizing agent, and catalyst composition according to the invention have a very good wettability and a good solubility or redispersibility, so that already on contact with water within a few seconds, at most through light stirring, the mixture is fully dissolved or redispersed. In addition, the materials can be used in many different ways and are very readily miscible with all sorts of dry and fresh mortars, as well as stored without any problems when they are mixed into dry mortars.

Surprisingly, only small amounts of the hydrophobizing material, hydrophobizing agent and/or catalyst composition are required in the process to hydrophobize mortars of the invention to obtain excellent hydrophobicity and a very low water uptake. It was unexpected to see that these amounts are clearly lower when compared to hydrophobizing agent-containing organopolysiloxanes.

In a special embodiment the catalyst composition containing the catalyst suitable for hydrolysis of the Si—OR bond and/or condensation of the Si—OH group obtained by hydrolysis is a water-dispersible, water-redispersible or water-soluble powder, granulate and/or flakes containing at least one carrier and a catalyst for hydrolysis of the Si—OR bonds and/or for condensation of the Si—OH groups obtained by hydrolysis. In this embodiment the carrier can be at least one organic water-soluble and/or water-dispersible polymer and the catalyst can be an organometallic compound. Thus, by combining this inventive catalyst composition with e.g. a commercially available silane composition, the inventive hydrophobizing material can be easily obtained.

As silane with at least one Si—OR group in principle all silanes and in particular organosilanes can be used, provided that they have at least one Si—OR group, wherein R is an organic group. However, it is often advantageous, though not necessary, when the boiling point at normal pressure of the used silane is not too low, preferably about 100° C. or higher. The silane can be soluble, insoluble or only partially soluble in water. Preferred in that case are silanes which have no or only a limited solubility in water. These can be alkoxysilanes of the formula R′ₐSi(OR)_{b}, wherein a and b have the value 1, 2 or 3 and the sum of a+b=4, and/or of the formula (R′)Si(OR)ₓO_{y}, with 0<x<2 and 0.5<y<1.5, preferably 1.0<x<2.0 and 0.5<y≦1.0, with the proviso that (2y+x)=3, silica esters of the formula Si(OR)₄, organoxysilanes of the formula Siₙ(OR)₄₋ₙ with n=1 to 3, di- and oligosilanes from units of the general formula R′_{c}H_{d}Si(OR)ₑ(OH)_{f}O_{(4-c-d-e-f)/2}, with c=0 to 3, d=0 to 2, e=0 to 3, f=0 to 3, and the sum of c+d+e+f of each unit is at most 3.5, wherein R′ stands for the same or different alkyl groups or alkoxyalkylene groups with 1 to 4 C-atoms and preferably signifies methyl or ethyl, R′ is the same or different and signifies branched or linear alkyl groups with 1 to 22 C-atoms, cycloalkyl groups with 3 to 10 C-atoms, alkylene groups with 2 to 4 C-atoms, aryl, aralkyl, alkylaryl groups with 6 to 18 C-atoms, wherein the mentioned groups R′ can also be substituted with halogens such as F or Cl, with ether, thioether, ester, amide, nitrile, hydroxyl, amine, carboxyl, sulfonic acid, carboxylic anhydride, and carbonyl groups, wherein in the case of polysilanes R′ can also have the meaning OR. Preferred are alkyl groups R′ with a C₁- to C₁₈-group, in particular with a C₂- to C₁₄-group, and especially preferably with a C₆- to C₁₂-group. Non-limititative examples are the methyl, ethyl, n-propyl, i-propyl, n-butyl, t-butyl, n-pentyl, neopentyl, n-hexyl, n-octyl, i-octyl, n-nonyl and/or lauryl group. When oligosilanes are used, they have a preferred degree of oligomerization of 2 to 10, in particular of 3 to 6.

Preferred silanes with at least one Si—OR group are alkoxysilanes and organosilanes having at least one carbon-silicon bond. Thus particularly preferred are alkylalkoxysilanes wherein the —OR of the Si—OR group is an alkoxy group and the organic group R is a saturated or unsaturated linear, branched and/or cyclic group with at least one hydrocarbon. As alkoxy groups are preferred alkoxy groups with at least one C₁- to C₁₂-group, in particular at least one C₁- to C₆-group. In an especially preferred embodiment at least one alkoxy group is a methoxy, ethoxy, n-propoxy, i-propoxy and/or butoxy group. Preferred alkyl groups of the alkylalkoxysilanes are methyl, ethyl, n-propyl, i-propyl, n-butyl, t-butyl, n-pentyl, neopentyl, n-hexyl, n-octyl, i-octyl, n-nonyl and/or lauryl groups. Less preferred are silanes with one or more silicon-linked hydrogen atoms.

Non-limiting examples of preferred alkylalkoxysilanes are alkyltrimethoxysilane, alkyltriethoxysilane, alkyltripropoxysilane with the alkyl group being a methyl, ethyl, n-propyl, i-propyl, n-hexyl, n-octyl, i-octyl, n-nonyl and/or lauryl group.

As carrier all known carriers can be used, provided they are suitable for the adsorption of organic compounds. Preferably, inorganic carriers and/or organic polymers are used.

Preferred inorganic carriers are anticaking agents, magnesium hydrosilicates, particulate titanium dioxide, aluminas, bleaching earths, activated alumina, vermiculites such as bentonite, expanded perlite, as well as phosphates such as Na-phosphate. Especially preferred are silicic acids with a BET-surface of at least 50 m²/g, in particular of at least 100 m²/g.

The organic polymers used as carriers can be water-soluble, water-insoluble and/or water-dispersible. As a rule the organic polymer is one or more synthetic polymers and/or at least one biopolymer such as polysaccharides, peptides and/or proteins, which may have been prepared naturally and/or synthetically. The organic polymer may optionally also be synthetically modified. As a rule the organic polymers, provided they are not dissolved or dispersed, are solids at room temperature and preferably higher molecular compounds. When several organic polymers are used, use can also be made of a combination of one or more natural compounds with one or more synthetically prepared compounds. Often it is advantageous when the organic polymers are water-soluble and/or water-dispersible.

Biopolymers and their derivatives preferably usable as carrier are cold water-soluble polysaccharides and polysaccharide ethers such as for instance cellulose ethers, starch ethers (amylose and/or amylopectin and/or their derivatives), guar ethers, dextrins and/or alginates. Also synthetic polysaccharides such as anionic, nonionic or cationic heteropolysaccharides can be used, in particular xanthan gum, welan gum and/or diutan gum. The polysaccharides can be, but do not have to be, chemically modified, for instance with carboxymethyl, carboxyethyl, hydroxyethyl, hydroxypropyl, methyl, ethyl, propyl, sulfate, phosphate and/or long-chain alkyl groups. Preferred peptides and/or proteins for use are for instance gelatin, casein and/or soy protein. Quite especially preferred biopolymers are dextrins, starches, starch ethers, casein, soy protein, gelatin, hydroxyalkyl-cellulose and/or alkyl-hydroxyalkyl-cellulose, wherein the alkyl group may be the same or different and preferably is a C₁ to C₆-group, in particular a methyl, ethyl, n-propyl- and/or i-propyl group. Synthetically prepared organic polymers preferred for use as a carrier can consist of one or several polymers, for instance one or more polyvinyl pyrrolidones and/or polyvinyl acetals with a molecular weight of 2,000 to 400,000, wholly or partially saponified polyvinyl alcohols and their derivatives, which can be modified for instance with amino groups, carboxylic acid groups and/or alkyl groups, with a degree of hydrolysis of preferably about 70 to 100 mol. %, in particular of about 80 to 98 mol. %, and a Höppler viscosity in 4% aqueous solution of preferably 1 to 100 mPas, in particular of about 3 to 50 mPas (measured at 20° C. in accordance with DIN 53015), as well as melamine formaldehyde sulfonates, naphthalene formaldehyde sulfonates, polymerizates of propylene oxide and/or ethylene oxide, including their copolymerizates and block copolymerizates, styrene-maleic acid and/or vinyl ether-maleic acid copolymerizates. Quite especially preferred are synthetic organic polymers, in particular partially saponified, optionally modified, polyvinyl alcohols with a degree of hydrolysis of 80 to 98 mol. % and a Höppler viscosity as 4% aqueous solution of 1 to 50 mPas and/or polyvinyl pyrrolidone.

The catalyst for hydrolysis of the Si—OR bond and/or for condensation of the Si—OH group preferably is an organometallic compound, also called a metallo-organic compound or metalorganic compound, and/or one or more amine compounds.

By organometallic compounds are meant compounds according to the invention which comprise an organic compound and/or an organic group linked directly to a metallic atom. In order to be suitable as a catalyst, as a rule the reaction speed of the hydrolysis of the Si—OR bond and/or the reaction speed of the condensation of the Si—OH group obtained by hydrolysis in an aqueous system at 23° C. and a pH-value of 7, at a weight ratio of the catalyst to the silane with at least one Si—OR bond of 1:10, is increased by least 10%, preferably by at least 50%, in particular by at least 200%.

According to the invention, preference is given to organometallic compounds which contain least one metal from Groups 3 to 15 of the Periodic System, in particular from Group 3 and Groups 14 and 15 of the Periodic System. As organometallic compounds tin, bismuth, zirconium and/or titanium compounds are quite particularly preferred.

The organic compound and/or the organic group linked directly to the metallic atom typically are ligands known from coordination chemistry, with compounds containing at least one or more carboxylates, polycarboxylates, hydroxy-carboxylates, amines, acetylacetonates, saturated and/or unsaturated, linear and/or branched alkyl, cycloalkyl, aryl and/or alkoxy groups being preferred, with alkyl and/or carboxylate compounds being especially preferred. According to the invention, one or several organometallic compounds can be used.

Non-limitative examples of suitable organometallic compounds are organotin compounds such as tinalkyl carboxylates and tin carboxylates, such as for instance dibutyltin(IV) dilaurate (DBTL), tin dioctoate, dibutyltin diacetate, dibutyltin oxide, tin(II) octoate, tin(II) acetates, tin(II) ethylcaproate, tin(II) palmitate, dibutyltin maleate, tin naphthenate, tin laurate, dibutyltin diacetyl acetonates, dioctyltin di(2-ethylhexanoate), dioctyltin dilaurate (DOTL), dioctyltin oxide, dibutyltin dicarboxylate, butyltin tris-(2-ethylhexanoate), dibutyltin dineo-decanoate, lauryl stannoxane, dibutyltin diketanoate, dioctyltin oxide (DOTO), dibutyltin diacetate (DBTA), dibutyltin dichloride, dibutyltin sulfide, dibutyltin oxide (DBTO), butyltin dihydroxychloride, butyltin oxide (MBTO), dibutyltin(dioctylmaleinate) and/or tetrabutyltin, organotitanium compounds such as alkyltitanates and alkyltitanate complexes, such as for instance zirconium carboxylates, tetrabutyl titanate, tetraisopropyl titanate, tetrapropyl titanate and/or tetraacetyl acetonatotitanate, organoaluminium compounds such as aluminium complexes, such as for instance trisacetylacetonatoaluminium, tris(ethylacetoacetato)aluminium, ethyl acetoacetatod iisopropoxyaluminium and/or aluminium lactate, organozirconium compounds such as zirconium complexes, such as for instance zirconium carboxylates, zirconium acetylacetonate and/or zirconium tetraacetylacetonate, organozinc compounds such as zinc carboxylates and further zinc complexes, such as for instance zinc-2-ethylcaproate, zinc-2-ethylhexanoate, zinc ricinoleate, zinc octoate, zinc acetylacetonate and/or zinc oxalate, bismuth compounds such as bismuth carboxylates and other bismuth complexes, such as for instance bismuth(III) tris(neodecanoate), bismuth(III)-2-ethylhexanoate, bismuth methane sulfonate, bismuth carboxylate, bismuth citrate and/or bismuth oxide.

Also, further organometallic compounds can be used, in particular based on lead, nickel, cobalt, iron, cadmium, chromium, copper and/or vanadium, such as for instance copper naphthenate, chromium acetylacetonate, iron acetylacetonate, iron naphthenate, cobalt acetylacetonate, cobalt naphthenate, molybdenum glycolates, lead octylate and/or lead naphthenate.

As amines can be used primary, secondary and/or tertiary amines. Often linear, branched and/or cyclic alkylamines are preferred, in which case the last can also be of an aromatic nature, such as for instance imidazole and its derivatives. As an example 2-ethyl-4-methylimidazole is mentioned.

Further typical representatives of the amines are alkylamines with saturated and/or unsaturated C₁- to C₂₄, in particular C₁- to C₁₂, alkyl groups, wherein amines with at least one methyl, ethyl, propyl, and/or butyl group are preferred and amines with at least one methyl and/or ethyl group are quite especially preferred.

In the hydrophobizing material and in particular in the hydrophobizing agent according to the invention the weight ratio of the catalyst to the silane with at least one Si—OR group is at least about 1:100, preferably at least about 1:25, in particular at least about 1:15, and/or at most about 1:1, preferably at most about 1:2, and in particular at most about 1:3.

In the hydrophobizing material, hydrophobizing agent and/or catalyst composition according to the invention the weight ratio of the catalyst to the carrier is at least about 1:100, preferably at least about 1:20, in particular at least about 1:4, and/or at most about 10:1, preferably at most about 3:1, in particular at most about 1:1.

The hydrophobizing material, hydrophobizing agent and/or catalyst composition according to the invention can contain still further additives. As to the nature of the further additives no real restrictions are imposed, so long as they do not enter into any undesired reactions. Often they have an important function in the application of the hydrophobizing material, hydrophobizing agent, catalyst composition, and mixtures containing these. If the additives are themselves powdery, they can for instance be easily added to the hydrophobizing material, hydrophobizing agent and/or catalyst composition in powder, granulate and/or flakes form. If they are liquid, the addition preferably takes place before and/or during the drying step in the preparation of the additives according to the invention. In this way for instance also further organic polymers can be added which are water-soluble and/or water-insoluble.

Preferred further additives are powdery and/or liquid antifoaming agents, wetting agents, alkyl, hydroxyalkyl and/or alkylhydroxyalkyl polysaccharide ethers such as cellulose ethers, starch ethers and/or guar ethers, with the alkyl and hydroxyalkyl group typically being a C₁ to C₄-group, synthetic polysaccharides such as anionic, nonionic or cationic heteropolysaccharides, in particular xanthan gum or welan gum, cellulose fibres, dispersing agents, rheology control additives, in particular liquefiers, thickeners and/or casein, hydration control additives, in particular setting accelerators, solidification accelerators and/or setting inhibitors, air entraining agents, polycarboxylates, polycarboxylate ethers, polyacrylamides, fully and/or partially saponified, and optionally modified, polyvinyl alcohols, polyvinyl pyrrolidones, polyalkylene oxides and polyalkylene glycols, with the alkylene group typically being a C₂ and/or C₃-group, which included also block copolymerizates, dispersions, and water-redispersible dispersion powders based on water-insoluble film-forming polymers such as for instance based on vinyl acetate, ethylene-vinyl acetate, ethylene-vinyl acetate-vinyl versatate, ethylene-vinyl acetate-(meth)acrylate, ethylene-vinyl acetate-vinyl chloride, vinyl acetate-vinyl versatate, vinyl acetate-vinyl versatate-(meth)acrylate, vinyl versatate-(meth)acrylate, pure (meth)-acrylate, styrene-acrylate and/or styrene-butadiene, wherein vinyl versatate preferably is a C₄ to C₁₂-vinyl ester, and the polymerizates can contain about 0-50 wt. %, in particular about 0-30 wt. %, and quite especially preferably about 0-10 wt. % of further monomers, in particular monomers with functional groups, further additives for hydrophobizing and/or for reducing the water absorption capacity, in particular based on silanes, siloxanes, silicones, metal soaps, fatty acids and/or fatty acid esters, additives for reducing blistering such as for instance compounds based on natural resins, in particular colophonium and/or its derivatives, fibres such as cellulose fibres, dispersing agents, additives for filling air voids, water retention agents and/or pigments. Fillers and/or aggregates such as quartzitic and/or carbonatic sands and/or powders such as for instance quartz sand and/or limestone powder, carbonates, silicates, chalks, layered silicates, precipitated silicas, light-weight fillers such as for instance hollow microspheres of glass, polymers such as polystyrene spheres, alumosilicates, silica, aluminium-silica, calcium-silicate hydrate, silicon dioxide, aluminium-silicate, magnesium-silicate, aluminium-silicate hydrate, calcium-aluminium-silicate, calcium-silicate hydrate, aluminium-iron-magnesium-silicate, calcium-metasilicate, clays such as bentonite and/or vulcanic slag as well as pozzolanes such as metakaolin and/or latently hydraulic components, in which case the fillers and/or light-weight fillers can also have a natural or artificially generated colour.

Quite especially preferred additives are polymer dispersions, dispersion and/or redispersion powder, further polysaccharide ethers, wetting agents, and hydrophobizing agents, in particular silanes, silane esters, siloxanes, fatty acids and/or fatty acid esters as well as rheology control additives.

For surface-active compounds for instance the proportion of these additives can be very small and be in the range of about 0.01 wt. % or higher, in particular about 0.1 wt. % and higher, but as a rule it will not exceed about 10 wt. %, in particular about 5 wt. %. On the other hand, for instance the proportion of water-redispersible polymer powder can be higher and can also be the 200-fold amount or higher of the hydrophobizing agent according to the invention and/or the catalyst composition according to the invention.

The process for the preparation of the catalyst composition according to the invention can be carried out in various ways. In a preferred process the catalyst is mixed with the carrier without the addition of water, with the carrier being used as a solid, in particular as a powder and/or granulate. In another preferred process the catalyst is mixed with the carrier in the presence of water and subsequently dried. In this embodiment it is advantageous as a rule when the carrier is a water-soluble and/or water-dispersible polymer.

There are also various ways of preparing the hydrophobizing agent according to the invention. In a preferred process the at least one silane with at least one Si—OR group is mixed with the carrier to a powder and/or granulate without the addition of water. The catalyst in this embodiment can either be sprayed on the powder and/or granulate and/or be added as a separate powder and/or granulate.

In another preferred embodiment the at least one silane with at least one Si—OR group is mixed with the carrier in the presence of water and dried, in which case it is advantageous when the carrier is a water-soluble and/or water-dispersible polymer. The addition of the catalyst then takes place for instance without further carrier before, during and/or after the drying, for instance by means of spraying. Depending on the method of drying, the result as a rule will be a powder, a granulate and/or flakes.

In a further preferred embodiment the at least one silane with at least one Si—OR group is mixed with the carrier and the catalyst in the presence of water and dried. In a separate step, the catalyst can be mixed with a carrier and optionally dried. If the addition of the catalyst takes place before the drying, preferably a water-soluble and/or water-dispersible polymer, which may be the same or different, is used as carrier for both steps. If the catalyst is added as a powder, granulate and/or flakes during and/or after the drying, the carrier for the silane with at least one Si—OR group preferably is a water-soluble or water-dispersible polymer and for the catalyst use can be made of the same and/or of another water-soluble and/or water-dispersible polymer, or alternatively an inorganic carrier can also be used.

The drying can take place by means of every suitable process. Preferred are spray drying, freeze drying, fluidized bed drying, drum drying, granulation such as for instance fluid bed granulation and/or rapid drying, with spray drying being especially preferred, and the spraying can take place for instance by means of a spraying wheel, one-component or multi-component nozzle. If necessary, the mixture to be dried can still be diluted with water, in order to achieve a suitable viscosity for the drying. The drying temperature in principle has no real limits. In particular because of safety-related considerations, however, it should not, as a rule, exceed about 200° C., in particular about 175° C. In order to attain sufficiently efficient drying, temperatures of about 110° C. or higher, in particular of about 120° C. or higher, are preferred.

The inventive hydrophobizing material, the hydrophobizing agent according to the invention, and the catalyst composition according to the invention can be present as a powder, granulate and/or flakes. As a rule it is advantageous when they are readily redispersible, dispersible and/or soluble in water. When they are present in the form of a powder and/or granulate, it is advantageous when the average size of the powder and/or granulate particles is at least about 10 μm or higher, preferably about 30 μm or higher, in particular about 50 μm or higher. Moreover, as a rule the particle size should be at most about 10 mm or less, preferably about 4 mm or less, in particular about 1 mm or less. Furthermore, it is helpful when the obtained products are readily fluid as well as block and storage stable.

When the catalyst compositions according to the invention are used, they have to be brought into contact with at least one silane with at least one Si—OR group before, during and/or after the application, for instance by means of the addition of a commercially available silane with at least one Si—OR group in the form of a powder, granulate, flakes and/or a liquid, in order to display the advantageous properties. When the silane with at least one Si—OR group is present as a powder and/or granulate, it is preferably either mixed with the catalyst composition beforehand, in which case as a rule the hydrophobizing material according to the invention results, or it is mixed with the dry mortar separately. When the silane with at least one Si—OR group is present in liquid form, the preferred addition of the silane with at least one Si—OR group takes place during the mixing of the dry mortar containing the powder, granulate and/or flakes with water.

Hydrophobizing material, hydrophobizing agents and/or silane compositions according to the invention are added to the masses preferably in amounts between about 0.01 and about 10 wt. %, in particular between about 0.1 and about 5 wt. %, and quite especially preferably between about 0.5 and about 2 wt. %, calculated on the dry content of the mass.

When catalyst compositions according to the invention are used, the content thereof preferably is between about 0.001 and about 1 wt. %, in particular between about 0.005 and about 0.5 wt. %, and quite especially preferably between about 0.01 and about 0.2 wt. %, calculated on the dry content of the mass.

The masses preferably are building material masses with or without minerally setting components. By this the skilled person means in particular mortar, concrete, plasters, coating systems, and construction adhesives. The building material masses as a rule contain one or more organic and/or inorganic binders. Quite especially preferred are masses in the form of mixtures, in particular dry mortars, which are mixed with water only shortly before application.

In a preferred embodiment the inventive hydrophobizing material, the hydrophobizing agents according to the invention, and the catalyst compositions according to the invention are used in gypsum-based masses. Such masses as a rule have a proportion of gypsum of at least 70 wt. %, in particular of at least 90 wt. %, calculated on the overall proportion of mineral binder, with the mineral binder, calculated on the dry content of the mass, being at least 15 wt. %, preferably at least 20 wt. %, in particular at least 35 wt. %. In another preferred embodiment the mass contains no mineral binder or less than 10 wt. %, preferably less than 5 wt. %, in particular less than 2 wt. %, calculated on the dry content of the mass. Besides the mineral binder, both embodiments can also additionally contain non-mineral binders.

By non-mineral binders are meant, in the meaning of the invention, powders as well as high- and/or low-viscous liquids. Preferred are water-soluble and/or water-dispersible polymers such as film-forming dispersions and/or redispersible dispersion powders based on emulsion polymerisates as well as epoxide resins.

By mineral binders are meant, in the meaning of the invention, binders which as a rule are powdery and in particular consist of at least a) a hydraulically setting binder, in particular gypsum, by which is meant in the meaning of this invention in particular calcium sulfate in the form of α- and/or β-semihydrate and/or anhydrite of form I, II and/or III, b) a latent hydraulic binder, in particular acidic blast-furnace slag, pozzolanes and/or metakaolin, and/or c) a non-hydraulic binder which reacts under the influence of air and water, in particular calcium hydroxide and/or calcium oxide.

As further hydraulically setting binders also cement can be used in small amounts, in particular Portland cement, for instance in accordance with EN 196 OEM I, II, III, IV, and V, and/or aluminous cement. As latent hydraulic binders pozzolanes such as metakaolin, calcium metasilicate and/or vulcanic slag, vulcanic tuff, trass, fly ash, blast-furnace slag and/or silica dust can be used, which react hydraulically in combination with a calcium source such as calcium hydroxide and/or cement. As non-hydraulic binder reacting under the influence of air and water in particular lime can be used, mostly in the form of calcium hydroxide and/or calcium oxide. Preferred above all are pure Portland cement-based construction material masses or a mixture of Portland cement, aluminous cement, and calcium sulfate, in which case optionally latently hydraulic and/or non-hydraulic binders may still be added to both systems.

In a further embodiment the hydrophobizing materials according to the invention can be applied as aqueous solution, dispersion, redispersion and/or as aqueous mass on any substrate, in order to provide it with a hydrophobizing surface. Non-limiting examples of such substrates are mineral building materials, bricks, component parts and/or constructions, mineral construction materials, such as concrete, lime sandstone, granite, lime, gypsum, marble, perlite, clinker, porous flags and tiles, natural stone, screed, clay articles but also artificial stone, masonries, facades, roofs, bricks, terracotta, as well as constructions such as bridges, docks, residential buildings, industrial buildings, and publicly used buildings such as multi-storey car parks, stations or schools, but also prefabricated components such as sleepers and/or L-shaped stones. Preferred are substrates which have no alkaline or acidic surfaces.

However, it is also possible to admix the hydrophobizing materials and/or the catalyst composition according to the invention in the preparation of the construction material mass as separate components. In the case of this embodiment it is often advantageous when the construction material components are mixed or kneaded with the required amount of water, with the hydrophobizing materials and/or the catalyst composition being added directly before, during and/or after the addition of water. However, it is also possible to add the hydrophobizing materials and/or the catalyst composition first to the mixing water and then add the whole to the dry or already wet mass in the mixer.

The mortars according to the invention preferably have a pH-value which is neither strongly acidic nor strongly alkaline. When the dry mortar is mixed with an equal amount by weight of water, then after the setting of the pH-constancy as a rule the pH-value of the mixed mortar at 23° C. is between about 4 and about 10, preferably between about 5.5 and about 8.5, in particular between about 5.5 and about 7.8.

Often the dry mortar according to the invention contains at least one minerally setting binder, which is added only in very small amounts, or else as main component, to the dry mortar.

In one preferred embodiment the dry mortar according to the invention is a gypsum dry mortar, wherein the proportion of gypsum, calculated on the dry mortar, is at least about 15 wt. %, preferably at least about 20 wt. %, and in particular at least about 35 wt. %.

Such dry mortars preferably contain about 15 to 75 wt. %, in particular about 20 to 70 wt. %, quite especially preferably about 30 to 65 wt. %, of at least one type of gypsum, about 20 to 80 wt. %, in particular about 25 to 75 wt. %, quite especially preferably about 30 to 65 wt. %, of at least one filler and/or aggregate, about 0.1 to 5 wt. %, in particular about 0.2 to 3 wt. %, quite especially preferably about 0.5 to 2 wt. %, of the hydrophobizing material to be used according to the invention or about 0.01 to 2 wt. %, in particular about 0.05 to 1 wt. %, quite especially preferably about 0.1 to 0.5 wt. %, of the catalyst composition to be used according to the invention, as well as up to about 5 wt. %, in particular 3 wt. % of further additives such as for instance polysaccharide ethers such as cellulose ethers and the alkyl and/or hydroxyalkyl derivatives thereof, retardants and/or accelerators, surface-active substances such as defoamers and/or wetting agents, and water-redispersible dispersion or redispersion powders and further additives known to the skilled person.

In another embodiment the dry mortar contains no or less than about 5 wt. %, in particular less than about 2.5 wt. %, calculated on the dry content of the dry mortar, of a minerally setting binder.

Such dry mortars preferably contain about 50 to 99.9 wt. %, in particular about 60 to 95 wt. % of at least one filler and/or aggregate, about 0.1 to 5 wt. %, in particular about 0.2 to 3 wt. %, quite especially preferably about 0.5 to 2 wt. %, of the hydrophobizing agent to be used according to the invention or about 0.01 to 2 wt. %, in particular about 0.05 to 1 wt. %, quite especially preferably about 0.1 to 0.5 wt. %, of the catalyst composition to be used according to the invention, about 3 to 40 wt. %, in particular about 5 to 30 wt. %, of water-redispersible dispersion or redispersion powder, as well as up to about 15 wt. %, in particular up to about 10 wt. %, of further additives such as for instance polysaccharide ethers such as cellulose ethers and the alkyl and/or hydroxyalkyl derivatives thereof, cellulose fibres, retardants and/or accelerators, surface-active substances such as defoamers and/or wetting agents, optionally minerally setting binders, as well as further additives known to the skilled person.

Suitable aggregates and/or fillers are known to the skilled person. Non-limiting examples are quartzitic and/or carbonatic sands and/or powders such as for instance quartz sand and/or limestone powder, carbonates, silicates, chalks, layered silicates and/or precipitated silicas. Furthermore, use may be made of light-weight fillers such as for instance hollow microspheres of glass, polymers such as polystyrene spheres, alumosilicates, silica, aluminium-silica, calcium-silicate hydrate, aluminium-silicate, magnesium-silicate, aluminium-silicate hydrate, calcium-aluminium-silicate, calcium-silicate hydrate silica, and/or aluminium-iron-magnesium-silicate, but also of clays such as bentonite, in which case the fillers and/or light-weight fillers can also have a natural or artificially generated colour.

The dry mortars according to the invention can be formulated for instance as coating or composite mortar, upgraded insulation mortar, sealing muds, gypsum and/or lime and/or cement plasters, repair mortar, joint adhesives, ceramic tile adhesives, plywood mortar, mortar for mineral bonding agents, cement primers, concrete coating mortar, powder coatings, parquet adhesives, levelling compounds and/or smoothing cements. As a result of the hydrophobicity and low water absorption obtained because of the hydrophobizing agent according to the invention or the powder, granulate and/or flakes according to the invention, such mortars can be used in the outdoor as well as the indoor area. Preferably, they are used in drywall installation, in plastering, in the handyman and do-it-yourself area, and have been formulated as adhesive putty, smoothing mortar, finish mortar, joint filler, joint sealer, ceramic tile adhesive, stucco work and/or moulding plaster composition, levelling compound, gypsum screeds, gypsum, gypsum-lime and/or synthetic resin plaster, pasty adhesive and/or water-based coating, or are used for producing gypsum plaster boards.

The invention is further elucidated with reference to the following Examples. Unless indicated otherwise, the experiments were carried out at a temperature of 23° C. and a relative humidity of 50%.

### A) Preparation of Powders

### EXAMPLE 1

### Preparation of Powder P-1

To 79.2 g of a 25% aqueous polyvinyl alcohol solution with a degree of hydrolysis of 88 mol. % and a Floppier viscosity as 4% solution of 4 mPas in a 250 ml glass vessel with a propeller stirrer were added at room temperature, with stirring at 1,000 rpm, 6.7 g of dibutyltin dilaurate (Merck), with the dibutyltin dilaurate being emulsified. The obtained emulsion was diluted with water to a solids content of 20 wt. % and subsequently dried without further additives by means of conventional spray drying at an initial temperature of 127° C. to a whitish, readily water-redispersible powder in good yield, in which process no contamination worth mentioning could be established in the spraying tower. The obtained powder was subsequently mixed with 0.5 wt. % of a commercially available silica and 10 wt. % of a commercially available carbonate.

### EXAMPLE 2

### Preparation of Powder P-2

To 266.7 g of a 25% aqueous polyvinyl alcohol solution with a degree of hydrolysis of 88 mol. % and a Floppier viscosity as 4% solution of 4 mPas in a 500 ml glass vessel with a propeller stirrer were added at room temperature, with stirring at 1,000 rpm, 33.3 g of a mixture of bismuth(III)-2-ethylhexanoate and C₃ to C₂₄-fatty acids (Borchers), with the additions being readily emulsified. The obtained emulsion was diluted with water to a solids content of 20 wt. % and subsequently dried without further additives by means of conventional spray drying at an initial temperature of 127° C. to a whitish, readily water-redispersible powder in good yield, in which process no contamination worth mentioning could be established in the spraying tower. The obtained powder was subsequently mixed with 0.5 wt. % of a commercially available silica.

### EXAMPLE 3

### Preparation of Powder P-3

Example 2 was repeated, with 266.7 g of polyvinyl alcohol solution and 33 g of a mixture of bismuth (III)-2-ethylhexanoate, lithium salt of C₉-C₁₁-fatty acids, and C₃-C₂₄-fatty acids being used. This resulted in a good yield of a whitish, readily water-redispersible powder.

### EXAMPLE 4

### Preparation of Powder P-4

To 310.8 g of a 25% aqueous polyvinyl alcohol solution with a degree of hydrolysis of 88 mol. % and a Höppler viscosity as 4% solution of 4 mPas in a 500 ml glass vessel with a propeller stirrer were added at room temperature, with stirring at 1,000 rpm, 33.3 g of dioctyltin dilaurate (Goldschmidt), with the dioctyltin dilaurate being readily emulsified. The obtained emulsion was diluted with water to a solids content of 25 wt. % and subsequently dried without further additives by means of conventional spray drying at an initial temperature of 120° C. to a whitish, readily water-redispersible powder in good yield, in which process no contamination worth mentioning could be established in the spraying tower.

### EXAMPLE 5

### Preparation of Powder P-5

To 155.4 g of a 50% aqueous solution of a Yellow Dextrin (Dextrin A330, Blattmann) in a 500 ml glass vessel with a propeller stirrer were added at room temperature, with stirring at 1,000 rpm, 33.3 g of dioctyltin dilaurate (Goldschmidt), with the dioctyl dilaurate being readily emulsified. The obtained emulsion was diluted with water to a solids content of 50 wt. % and subsequently dried without further additives by means of conventional spray drying at an initial temperature of 120° C. to a pale yellowish, readily water-redispersible powder in good yield, in which process no contamination worth mentioning could be established in the spraying tower.

### EXAMPLE 6

### Preparation of Powder P-6

A water-redispersible powder based on 50 parts by weight of Yellow Dextrin (Dextrin A330, Blattmann) and 50 parts by weight of octyltriethoxysilane was prepared in analogous manner to Example 5, which resulted in a readily water-redispersible powder in good yield, in which process no contamination worth mentioning could be established in the spraying tower.

### EXAMPLE 7

### Powder P-7

Powder P-7 is a commercially available, water-redispersible powder based on polyvinyl alcohol and octyltriethoxysilane which is used for hydrophobizing in alkaline, in particular in cement-based systems.

### B) Preparation of Hydrophobizing Agents

### EXAMPLE 8

### Preparation of Hydrophobizing Agent HM-1

10.7 parts by weight of powder P-2 were mixed by hand with 89.3 parts by weight of powder P-7.

### EXAMPLE 9

### Preparation of Hydrophobizing Agent HM-2

Example 8 was repeated, with 15 parts by weight of powder P-2 and 85 parts by weight of powder P-7 being used.

### EXAMPLE 10

### Preparation of Hydrophobizing Agent HM-3

Example 8 was repeated, with 15 parts by weight of powder P-3 and 85 parts by weight of powder P-7 being used.

### EXAMPLE 11

### Preparation of Hydrophobizing Agent HM-4

Example 8 was repeated, with 10.7 parts by weight of powder P-1 and 89.3 parts by weight of powder P-7 being used.

### EXAMPLE 12

### Preparation of Hydrophobizing Agent HM-5

In analogous manner to Example 8, 10 parts by weight of powder P-6 were mixed with 1.7 parts by weight of powder P-4.

### EXAMPLE 13

### Preparation of Hydrophobizing Agent HM-6

Example 12 was repeated, with powder P-5 being used instead of powder P-4.

### EXAMPLE 14

### Preparation of Hydrophobizing Agent HM-7

In analogous manner to Example 12, Dextrin and octyltriethoxysilane were mixed with one another. Subsequently, 6 parts by weight of dibutyltin dilaurate, calculated on 94 parts by weight of the sum of Dextrin and octyltriethoxysilane (solids content), were added with stirring and further mixed for 5 minutes. The obtained mixture was spray dried according to Example 5.

### EXAMPLE 15

### Preparation of Hydrophobizing Agent HM-8

Example 14 was repeated, with polyvinyl alcohol with a degree of hydrolysis of 88 mol. % and a Höppler viscosity as 4% solution of 4 mPas being used instead of Dextrin and dioctyltin dilaurate being used instead of dibutyltin dilaurate.

### EXAMPLE 16

### Preparation of Hydrophobizing Agent HM-9

Into a 500 ml beaker were put 10 g of an expanded perlite (powder density 80-120 kg/m³). Added dropwise, with stirring, was a mixture of 3.36 g of octyltriethoxysilane and 0.64 g dioctyltin dilaurate, with the pourability remaining unchanged.

### C) Preparation of Dry Mortar Master Batches

### EXAMPLE 17

### Preparation of Cement- and Gypsum-Free Dry Mortar Masterbatch TM-1

Prepared were 5 kg of a cement- and gypsum-free dry mortar master batch TM-1, consisting of 353 parts by weight of a calcium carbonate (Durcal 65), 608 parts by weight of a quartz sand (0.1-0.5 mm), 35 parts by weight of titanium dioxide (Kronos 2044), 1.2 parts by weight of a commercially available powder antifoaming agent (Agitan P 801, Münzing), as well as 2.4 parts by weight of a commercially available cellulose ether (methylhydroxyethyl cellulose), in which process the components were mixed in a 10 l boiler with a FESTO stirrer until a homogeneous dry mortar master batch was obtained.

### EXAMPLE 18

### Preparation of Gypsiferous Dry Mortar Master Batch TM-2

Dry mortar master batch TM-2 was prepared in analogous manner to TM-1, but with use being made of 520 parts by weight of Hartform 1 (hemihydrate), 332 parts by weight of a natural calcium carbonate (Omyacarb BG10), 55 parts by weight of an aluminium-silicon-hydrate (kaolin), 90 parts by weight of a coalesced mica/chlorite/talcum mineral (Plastorit 0.25), 3 parts by weight of a commercially available cellulose ether (methylhydroxyethyl cellulose), 0.2 parts by weight of a commercially available retarder (Retardan P), and 2 parts by weight of a commercially available dispersion powder based on an ethylene-vinylacetate copolymerizate (Elotex MP2087). The pH-value of the mortar, mixed 1:1 with water until the pH was constant, was 7.5.

### EXAMPLE 19

### Preparation of a Gypsum-Based Dry Mortar Master Batch TM-3

Dry mortar master batch TM-3 was prepared in analogous manner to TM-1, but with use being made of 420 parts by weight of Almod Beta gypsum, 100 parts by weight of Hartform gypsum (hemihydrate), 302 parts by weight of a natural calcium carbonate (Omyacarb BG10), 55 parts by weight of an aluminium-silicon-hydrate (kaolin), 90 parts by weight of a coalesced mica/chlorite/talcum mineral (Plastorit 0.25), 20 parts by weight of a commercially available dispersion powder based on an ethylene-vinylacetate copolymerizate (Elotex MP2080), 5 parts by weight of a commercially available cellulose ether, and 0.2 parts by weight of a commercially available retarder (Retardan).

### D) Application-Specific Tests

### Preparation of the Mortar Premix:

The amounts (parts by weight) of the dry mixture in question indicated in Tables 1 to 6 were first dry-mixed with the further powdery additives as well as the powder according to the invention. Subsequently the mixtures in question were mixed with the amounts of water, calculated on 100 parts of dry mortar formulation, indicated in the Tables, using a 60 mm propeller stirrer with a speed of 800 rpm for 60 seconds, with the mixing water being introduced into the mixture. After a maturing time of 3 minutes the mortar was again briefly stirred by hand and applied with a plastering trowel and optionally with the aid of spacer rails.

### EXAMPLE 20

### Determination of the Wet Abrasive Resistance (Weight Loss as a Result of Wet Abrasion)

The finished mixture was applied in 1 mm layer thickness on a fibrated cement board and stored for 4 days at 23° C./55% relative humidity. The sample was weighed and then inserted into a brushing machine. A nylon brush of 30×80 mm (50 g) was provided with an applied load of 460 g. Dropped continuously onto the sample was an aqueous, 0.25% sodium dodecyl sulfonate solution. The brush in a single cycle made a passage of 130 mm back and forth. After 1,000 cycles the sample was rinsed, wiped off, and dried for 16 hours at 50° C. The weight loss is the brushed off material.

TABLE 1
Determination of the weight loss after wet abrasion of cement-
and gypsum-free dry mortar master batch TM-1 (85 parts by
weight), mixed with different powdery additives (specification
in parts by weight) and with an amount of 17 wt. % of mixing
water (on 100 wt. % dry mortar formulation).

| Experiment No. | 1.1 (Ref.) | 1.2 (Ref.) | 1.3 | 1.4 | 1.5 |
|---|---|---|---|---|---|
| ELOTEX FLEX8300 ^{a)} | 15 | 13.5 | 13.5 | 13.5 | 13.5 |
| powder P-7 | | 1.5 | 1.35 | 1.35 | 1.275 |
| powder P-1 | | | 0.15 | | |
| powder P-2 | | | | 0.15 | |
| powder P-3 | | | | | 0.225 |
| weight loss [in %] | 85 | 90 | 33 | 45 | 50 |

The weight loss (in wt. %) relates to the surface on which the brush moves back and forth during the cycles.
^{a)} ELOTEX FLEX8300 is a water-redispersible dispersion powder based on an acrylate copolymer

TABLE 2
Determination of weight loss in analogous manner to Table 1, with
the amount of mixing water (specifications relate to the
dry content of the dry mortar formulation)
set to the same consistency. The volume loss was
evaluated visually.

| | Experiment No. | | | | | | |
|---|---|---|---|---|---|---|---|
| | 2.1 | 2.2 | 2.3 | | | | |
| | (Ref.) | (Ref.) | (Ref.) | 2.4 | 2.5 | 2.6 | 2.7 |
| ELOTEX | 15 | 15 | 15 | 15 | 15 | 15 | 15 |
| FLEX8300 ^{a)} | | | | | | | |
| Powder P-7 | | 1.5 | | 1.425 | 1.35 | | |
| Powder P-1 | | | 0.075 | 0.075 | 0.15 | | |
| HM-1 | | | | | | 1.5 | |
| HM-3 | | | | | | | 1.5 |
| mixing water | 17 | 18 | 17 | 18 | 18 | 18 | 18 |
| [wt. %] | | | | | | | |
| Volume loss | 90 | 60 | 80 | 25 | 20 | 40 | 40 |
| visually [%] | | | | | | | |

^{a)} see Table 1.

The results in Tables 1 and 2 clearly show that with the hydrophobizing agent according to the invention as well as with the powder according to the invention in combination with powders containing alkoxysilanes even cement- and gypsum-free dry mortars can be formulated which after application show a clearly increased wet abrasive resistance of the dried and cured mortar.

### EXAMPLE 21

### Determination of the Water Absorption of Gypsum Mortar Cylinders

The mixed mortar premix was charged to a mortar cylinder of polypropylene with a diameter of 80 mm and a height of 20 mm. The obtained samples were taken out after 16 hours at 23° C., subsequently dried at 45° C. for 24 hours, and stored for a further 3 days at 23° C./50% relative humidity. The specimens were weighed and stored for 2 hours at 23° C. in water with a water cover of 2 cm. The wet sample was subsequently wiped off and weighed, from which the weight increase in percentage terms could be calculated.

TABLE 3
Determination of the water absorption of gypsum mortar
cylinders prepared from dry mortar master batch TM-2 (102
parts by weight) with an amount of mixing water of 37 wt.
%, calculated on 100 wt. % dry mortar formulation.

| Experiment No. | 3.1 (Ref.) | 3.2 (Ref.) | 3.3 |
|---|---|---|---|
| powder P-7 | | 0.5 | 0.5 |
| powder P-1 | | | 0.06 |
| water absorption [wt. %] | 8.7% | 7.1% | 3.4% |

It is clear from Table 3 that the addition of just powder P-7 to gypsum mortars has only a minor effect on the reduction of the water absorption. When, on the other hand, only a small proportion of the powder according to the invention is added thereto, which together with alkoxysilane-containing powder forms a hydrophobizing agent combination according to the invention, the water absorption undergoes a very clear reduction.

### EXAMPLE 22

### Determination of the Water Absorption of Gypsum Mortars on EPS-Boards

After 3 minutes of maturing time, the mixed mortar premixes were applied by means of 2 mm thick spacing means onto 10 mm thick EPS-boards (Expanded Polystyrene; 15 kg/m³) and stored at 23° C./50% relative humidity for 7 days. After 6 days polypropylene cylinders with a diameter of 81 mm and a height of 20 mm were cemented on with the aid of silicone cement.

The boards were weighed, with the cemented on cylinders subsequently being filled with 90 g of water and left for 2 hours. After removal of the water the wet surface was wiped off and reweighed. The difference in values produced the water absorption, which is indicated in g/m².

TABLE 4
Determination of the water absorption of gypsum mortars prepared
from dry mortar master batch TM-3 (99.2 parts by weight)
with an amount of mixing water of 44 wt. %, calculated on
100 wt. % dry mortar formulation, on EPS-boards.

| Experiment No. | 4.1 (Ref.) | 4.2 | 4.4 | 4.3 | 4.5 |
|---|---|---|---|---|---|
| powder P-7 | 0.5 | | | | |
| HM-4; freshly mixed ^{a)} | | 0.5 | | 0.7 | |
| HM-4; stored ^{b)} | | | 0.5 | | 0.7 |
| water absorption [g/m²] | 754 | 429 | 449 | 373 | 368 |

^{a)} The mixture was made into a paste and processed immediately after mixing with water.
^{b)} The mixture was first stored for 5 days at 45° C. in a container sealed airtight. Processing followed after the mixture was cooled to room temperature.

The use of small amounts of hydrophobizing agent according to the invention clearly reduces the water absorption of gypsum mortars, irrespective of whether the hydrophobizing agent was stored at elevated temperatures beforehand, as is clear from Table 4.

### EXAMPLE 23

### Determination of the Water Absorption of Gypsum Mortars on Gypsum Plasterboards

After 3 minutes of maturing time, the mixed mortar premixes were applied by means of 1.5 mm thick spacing means on gypsum plasterboards in accordance with the EN 520 Standard (Type H) and stored at 23° C./50% relative humidity for 7 days. After 6 days polypropylene cylinders with a diameter of 115 mm and a height of 60 mm were cemented on with the aid of silicone cement.

The boards were weighed, with the cemented on cylinders subsequently being filled with 250 g of water and left for 2 hours. After removal of the water the wet surface was wiped off and reweighed. The difference in values produced the water absorption, which is indicated in g/m² (see Table 5).

TABLE 5
Determination of the water absorption of gypsum mortars prepared
from a customer's dry mortar master batch based on gypsum
with an amount of mixing water of 45 wt. %, calculated on 100
wt. % dry mortar formulation, on gypsum plasterboards.

| hydrophobizing agent | | |
|---|---|---|
| additive | amount (wt. %)^{a)} | water absorption [g/m²] |
| No mortar | 0 | 769 |
| P-5 (Ref.) | 0.40 | 704 |
| P-6 (Ref.) | 1.0 | 876 |
| HM-5 | 1.17 | 173 |
| HM-6 | 1.17 | 183 |
| HM-7 | 1.06 | 126 |
| HM-8 | 1.05 | 154 |
| HM-9 | 1.5 | 162 |
| HM-9 | 2.1 | 152 |

The pH-value of the mixture made into a paste was 7.5.
^{a)}The customer's dry mortar master batch was supplemented to 100 wt. %.

The data in Table 5 shows that with the hydrophobizing agents according to the invention very low water absorptions are obtained, which are comparable with those of gypsum plasterboards “Type H”. This is necessary in order to have no discolorations after application of the gypsum mortar on the gypsum plasterboard.

### EXAMPLE 24

### Determination of the Surface Hydrophobicity

The mixed mortar premixes were applied 5 mm thick on fibrated cement boards with plastering trowels and spacer rails. After 4 days at 23° C./50% relative humidity part of the surface was scraped off about 1 mm deep with a corundum stone and dusted off. On the surface which was not scraped off as well on the scraped-off surface were each applied 5 drops (0.2 ml) of water and the time was measured until no water was visible on the surface any longer.

TABLE 6
Determination of the surface hydrophobicity of gypsum mortars
prepared from dry mortar master batch TM-2 (102 parts by weight)
with an amount of mixing water of 37 wt. %, calculated on 100
wt. % dry mortar formulation, on fibrated cement boards.

| | Experiment No. | | | | |
|---|---|---|---|---|---|
| | 3.1 | 3.2 | | | |
| | (Ref.) | (Ref.) | 3.3 | 3.4 | 3.5 |
| Powder P-7 | | 0.5 | 0.5 | 0.45 | 0.5 |
| Powder P-1 | | | 0.06 | | |
| Powder P-2 | | | | 0.05 | |
| Powder P-3 | | | | | 0.09 |
| Surface hydrophobicity [min]: | | | | | |
| scraped-off surface | 2 | 4 | 14 | 15 | 11 |
| surface not scraped off | 20 | 16 | 90 | 40 | 60 |

The use of hydrophobizing agents according to the invention or the combination of powders according to the invention with known powders containing alkoxysilanes not only reduces the water absorption, but also improves the surface hydrophobicity. The fact that even in the case of scraped-off surfaces this is still many times higher than in the case of the reference examples shows that not only the surface but also the mass as such is hydrophobized.

1. A process to hydrophobize mortars, comprising mixing a dry mortar with water, applying the mixture onto a substrate and allowing it to dry, wherein the dry mortar is a gypsum dry mortar or containing at least one filer or aggregate and no or less than about 5 wt. % of a minerally setting binder, calculated on the dry content of the dry mortar, wherein at least one solid hydrophobizing material is added before, during or after mixing of the dry mortar with water or the hydrophobizing material is mixed with water and applied onto the dried mortar,
wherein the hydrophobizing material is
i) a hydrophobizing agent containing a silane, a carrier, and a catalyst, or
ii) a silane composition containing at least a silane and a carrier and a catalyst composition containing at least a catalyst and a carrier, wherein the silane and catalyst compositions are added to the mortar together or separately before, during or after mixing of the mortar with water,
wherein the silane has at least one Si—OR group and R is an organic group, the catalyst is suitable for hydrolyzing the Si—OR bond or for condensation of the Si—OH group obtained by hydrolysis and wherein the carrier is an inorganic carrier or organic polymer and is selected from the group of anticaking agents, magnesium hydrosilicates, particulate titanium dioxide, aluminas, bleaching earths, activated alumina, vermiculites, expanded perlite, phosphates, silicic acids with a BET-surface of at least 50 m²/g and water-soluble, water-insoluble or water-dispersible organic polymer.

2. A dry mortar containing at least one of the group of gypsum, filler and aggregate and at least one solid hydrophobizing material, the hydrophobizing material being
i) a hydrophobizing agent containing a silane, a carrier, and a catalyst, or
ii) a silane composition containing at least a silane and a carrier and a catalyst composition containing at least a catalyst and a carrier,
wherein the silane has at least one Si—OR group, wherein R is an organic group, the catalyst is suitable for hydrolyzing the Si—OR bond or for condensation of the Si—OH group obtained by hydrolysis and wherein the carrier is an inorganic carrier or organic polymer and is selected from the group of anticaking agents, magnesium hydrosilicates, particulate titanium dioxide, aluminas, bleaching earths, activated alumina, vermiculites, expanded perlite, phosphates, silicic acids with a BET-surface of at least 50 m²/g and water-soluble, water-insoluble or water-dispersible organic polymer.

3. The dry mortar according to claim 2, wherein the dry mortar is a gypsum dry mortar or wherein the dry mortar contains no or less than about 5 wt. %, calculated on the dry content of the dry mortar, of a minerally setting binder.

4. The dry mortar according to claim 2, wherein the amount of the hydrophobizing agent or of the silane composition is between about 0.01 and about 10 wt. % or the amount of the catalyst composition is between about 0.001 and about 1 wt. %, calculated on the dry content of the dry mortar.

5. The dry mortar according to claim 2, wherein the pH value of the dry mortar, when mixed with the same amount by weight of water, is between about 4 and about 10.

6. A hydrophobizing agent containing at least one silane, one catalyst, and one carrier, wherein
i) the silane has at least one Si—OR group, wherein R is an organic group,
ii) the carrier is an inorganic carrier or an organic polymer and is selected from the group of anticaking agents, magnesium hydrosilicates, particulate titanium dioxide, aluminas, bleaching earths, activated alumina, vermiculites, expanded perlite, phosphates, silicic acids with a BET-surface of at least 50 m²/g and a water-soluble or a water-dispersible organic polymer,
iii) the catalyst is a catalyst for hydrolysis of the Si—OR bond or for condensation of the Si—OH group obtained by hydrolysis, and
wherein the hydrophobizing agent is present in solid form.

7. The hydrophobizing agent according to claim 6 wherein the weight ratio of the catalyst to the silane is at least about 1:100 and the weight ratio of the catalyst to the carrier is at least about 1:100.

8. The hydrophobizing agent according to claim 6, wherein the silane is an alkoxysilane of the formula R′ₐSi(OR)_{b}, wherein OR is an alkoxy group, R is an organic group, R′ is the same as or different from R and is a branched or linear alkyl group with 1 to 22 C-atoms, a cycloalkyl group with 3 to 10 C-atoms, an alkylene group with 2 to 4 C-atoms or an aryl group, and a and b have the value 1, 2 or 3 and the sum of a+b=4.

9. The hydrophobizing agent according to claim 6, wherein the catalyst is an organometallic compound or an amine.

10. A catalyst composition containing at least
i) one carrier, wherein the carrier is at least one organic water-soluble or water-dispersible polymer, and
ii) one catalyst for hydrolysis of Si—OR bonds or for condensation of Si—OH groups obtained by hydrolysis, wherein the catalyst is an organometallic compound,
wherein the catalyst composition is a water-dispersible, water-redispersible or water-soluble catalyst composition and is present in solid form.

11. The catalyst composition according to claim 10, wherein the weight ratio of the catalyst to the carrier is at least about 1:100.

12. The catalyst composition according to claim 10, wherein the organometallic compound contains a tin, bismuth, zirconium or titanium compound.

13. A process for the preparation of the catalyst composition according to claim 10, wherein the process comprises
i) mixing the catalyst with the carrier without the addition of water, wherein the carrier is a solid, or
ii) mixing the catalyst with the carrier in the presence of water and subsequently drying the composition, wherein the carrier is a water-soluble or water-dispersible polymer.

14. A process for the preparation of the hydrophobizing agent according to claim 6, wherein the process comprises
i) mixing the silane having at least one Si—OR group with the carrier without the addition of water to a powder or granulate, and after that spraying thereon or adding thereto the catalyst as a separate powder or granulate, or
ii) mixing the silane having at least one Si—OR group with the carrier in the presence of water and drying the mixture, wherein the carrier is a water-soluble or water-dispersible polymer, and adding the catalyst before, during or after the drying, or
iii) mixing the at least one silane having at least one Si—OR group with the carrier and the catalyst in the presence of water and drying the mixture, wherein mixing the catalyst with the carrier is in a separate step, wherein the carrier is a water-soluble or water-dispersible polymer and the carrier may be the same or different.

15. A method of hydrophobizing masses, reducing the water absorption of masses, or protecting masses or metal coated with these masses against corrosion, comprising applying a hydrophobizing agent according to claim 6 to said masses, wherein when the catalyst composition is used, it is brought into contact with at least one silane having at least one Si—OR group before, during or after the application.

16. A method of hydrophobizing masses, reducing the water absorption of masses, or protecting masses or metal coated with these masses against corrosion, comprising applying a catalyst composition according to claim 10 to said masses, wherein when the catalyst composition is used, it is brought into contact with at least one silane having at least one Si—OR group before, during or after the application.

17. The dry mortar according to claim 2, wherein the silane is an alkoxysilane of the formula R′ₐSi(OR)_{b}, wherein OR is an alkoxy group, R is an organic group, R′ is the same as or different from R and is a branched or linear alkyl group with 1 to 22 C-atoms, a cycloalkyl group with 3 to 10 C-atoms, an alkylene group with 2 to 4 C-atoms or an aryl group, and a and b have the value 1, 2 or 3 and the sum of a+b=4.

18. The dry mortar according to claim 2, wherein the catalyst is an organometallic compound or an amine.

19. The dry mortar according to claim 9, wherein the organometallic compound contains a tin, bismuth, zirconium or titanium compound.

20. The hydrophobizing agent according to claim 9, wherein that the organometallic compound contains a tin, bismuth, zirconium or titanium compound.
